(19) United States
(12) Patent Application Publication
(10) Pub. No.: US 2009/0225025 A1
(43) Pub. Date: Sep. 10, 2009

(54) Graphical user interface for multi-point ionizer control

(76) Inventor: Brian J. Warren, Reno, NV (US)

Correspondence Address: MKS/Ion Systems;Attn: John E. Menear, Suite 100, 1750 North Loop Road, Alameda, CA, 94502, US

(21) Appl. No.: 12/074,576

(22) Filed: Mar. 5, 2008

(51) Int. Cl. G09G 5/00

(52) U.S. Cl. 345/156

(57) ABSTRACT

A graphic user interface used to activate novel features cited in U.S. application Ser. Nos. 11/651,120 and 11/648,275. An interactive field for feedback averages is used to determine the percentage of an accumulator's output that is fed back to the accumulator's input. Feedback averages determine the response time of remote sensors that control ionizers. A gain field is used to appropriately set the signal-to-noise and resolution of transmitted signals from remote sensors. A calibrate field is used to offset the balance of a remote sensor to zero, and match the swing of the remote sensor to a known swing at a distant target.

### CROSS-REFERENCE TO RELATED APPLICATIONS

Not Applicable

### STATEMENT REGARDING FEDERALLY SPONSORED RESEARCH

Not Applicable

### REFERENCE TO A MICROFICHE APPENDIX

Not Applicable

### BACKGROUND OF THE INVENTION

1. Field of the Invention

This invention relates to software control of one or more ionizers, which are designed to remove or minimize static charge accumulation. In particular, the invention addresses the graphical user interface which configures and monitors both ionizers and feedback sensors via an intermediate control module.

2. Description Of Related Art

Ionizers remove static charge by generating air ions and delivering those air ions to a charged target. Performance of the ionizer (or ionizers) is typically defined by discharge time, balance, and swing. Discharge time is a measure of how quickly a known charge is neutralized. Balance is a measure of whether positive and negative air ion concentrations are equal at the target. Ideal balance is zero.

Swing represents the peak-to-peak voltage excursions around the mean balance. Swing is important because sensitive electronic devices can be destroyed by excessive swing, even if balance is near zero.

At installation, values for discharge time, balance, and swing are established.

After installation, sensor feedback is used to maintain the initial conditions. Sensors can be integrated into an ionizer. Or remote sensors, usually near the target zone, can send adjustment signals back to ionizers.

Sensor integration allows the ionizer to maintain its performance within a limited range. The advantages of integrated architecture are (1) control is automatic, and (2) the operator does not have to get involved. The disadvantages are: (1) that control may not be sufficient for critical semiconductor, disk drive, and flat panel display applications, and (2) that the sensor may not reflect the conditions at the target.

One or more remote sensors near the target zone, and can be used to control one or more ionizers. This provides excellent control, and the remote sensor can be distant from the target. An example of a novel remote sensor is described in U.S. patent application Ser. No. 11/648,275, which is commonly owned by MKS Instruments at the time of this instant application filing. U.S. patent application Ser. No. 11/648,275 is entirely incorporated herein by reference.

In a particularly useful and novel architecture, all ionizers and all sensors are connected via an intermediate module to a computer. This novel architecture is described in U.S. patent application Ser. No. 11/651,120 which is commonly owned by MKS Instruments at the time of this instant application filing. U.S. patent application Ser. No. 11/651,120 is entirely incorporated herein by reference.

In practice, prototypes have demonstrated that this architecture is very flexible. For example, sensors can be placed virtually anywhere within the ionized work space, and calibrated to control ionizers positioned at distant locations.

The novel remote sensor of U.S. patent application Ser. No. 11/648,275 and the novel architecture of U.S. patent application Ser. No. 11/651,120 may be combined into an ionizing system.

However, a graphical user interface is needed that allows an operator to monitor and control the ionizing system.

### BRIEF SUMMARY OF THE INVENTION

The present invention is a graphical user interface that allows an operator to monitor and control an ionizing system of multiple ionizers, multiple remote sensors, and an intermediate module.

Novelty for the instant graphical user interface arises from interfacing to novel features within U.S. application Ser. Nos. 11/651,120 and 11/648,275. Operator-controllable fields within the graphical interface activate hardware and software components, which are recited in U.S. application Ser. Nos. 11/651,120 and 11/648,275 during setup, calibration and operation.

### BRIEF SUMMARY OF THE FIGURES

FIG. 1 is an example of an interface screen for the invented graphic user interface. It shows fields for display and adjustment of feedback averages. Buttons for “set gain”, and “calibrate” are utilized during installation and calibration of remote sensors.

FIG. 2 shows a remote sensor connected to a first summing block, a second summing block, an accumulator, and a gain block setting. Feedback averages (displayed in FIG. 1) are related to the percentage of feedback through a feedback loop which includes the accumulator.

FIG. 3 diagrams a remote sensor that is serially connected to a digitally-controlled analog amplifier and a programmable-gain amplifier. The “set gain” button (displayed in FIG. 1) automatically adjusts operating parameters for the digitally-controlled analog amplifier and the programmable-gain amplifier.

FIG. 4 shows the feedback loop implemented in the intermediate module that is initiated when the “calibrate” button (displayed in FIG. 1) is activated. In the graphical interface, when feedback is enabled, the real-time swing and real-time balance are loaded and stored in the swing set-point register and the balance set-point register, respectively.

### DETAILED DESCRIPTION

The invented graphical user interface is described from two interconnected viewpoints. The first viewpoint addresses fields on computer screens that the operator uses to communicate with the ionizing system. The second viewpoint addresses responses created within the ionizing system via the graphical user interface. The ionizing system (hardware and software) that is addressed via the graphical user interface embodies the technologies described by U.S. application Ser. Nos. 11/651,120 and 11/648,275.

The ionizing system itself employs two technologies (1) remote sensors and (2) and an architecture for multiple ionizers and multiple remote sensors. The architecture employs an intermediate module wherein (1) the intermediate module receives information from sensors and ionizers, (2) hardware and algorithms within the intermediate module process the received information, and (3) the intermediate module forwards information back to sensors and ionizers.

A computer with the graphic user interface connects to the intermediate module.

Communication is bidirectional. Commands or adjustments from the computer are sent through the intermediate module to the ionizers and sensors. Information from the ionizers and sensors are sent through the intermediate module to the computer. Using the graphical user interface, an operator sets up the ionizing system, calibrates the ionizing system, and monitors the ionizing system.

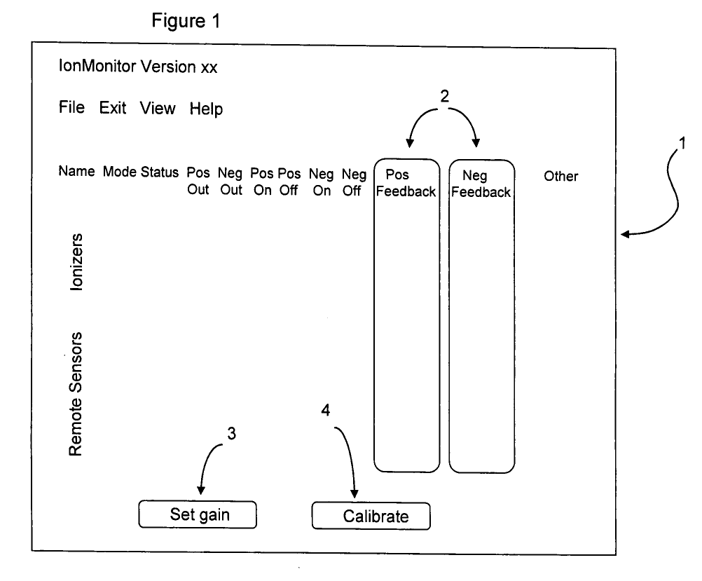

FIG. 1 shows one layout embodiment for a top level screen of the graphic user interface 1.

Fields within the graphic interface 1 are used to activate the novel features of U.S. application Ser. Nos. 11/651,120 and 11/648,275.

For example, positive and negative feedback averages 2 within the graphic interface 1 are used to control the time necessary to recover from a balance disturbance.

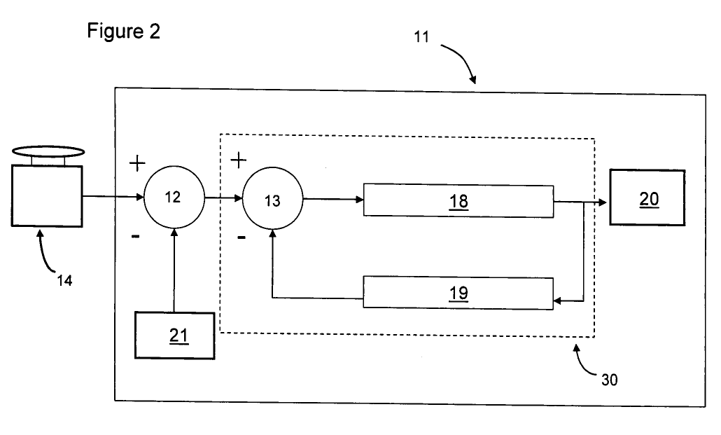

FIG. 2 shows the components of the ionizer system that relate to feedback averages 2. Feedback averages 2 allow an operator to monitor or change the level of feedback through an accumulator 18. In a best mode contemplated, the accumulator 18 is housed within an intermediate module 11.

The accumulator 18 receives signal information from the remote sensor 14 through two summing blocks 12, 13. The second summing block 13 is part of a feedback loop 30 which further includes the gain block 19. Gain block 19 determines the fraction of the accumulator 18 output which is returned to the input of the accumulator 18 via the second summing block 13.

Changing the feedback averages 2 in FIG. 1 changes the gain block 19 in FIG. 2, which in turn changes the fraction of the accumulator 18 output that is returned to the accumulator 18 input via the second summing block 13.

Feedback averages 2 (positive and negative) in FIG. 1 are unique to the invented graphical interface. Their inclusion reflects unique technology diagrammed in FIG. 2. No other ionizer system employs summing blocks 12, 13, an accumulator 18, and gain block 19 technology in an equivalent way to achieve an equivalent feedback mechanism.

Feedback averages 2 within FIG. 1 are also utilized during the matching procedure, wherein a remote sensor's balance is adjusted to match a known ion balance at a distant location.

The feedback averages 2 in FIG. 1 determine the gain block 19 setting in FIG. 2. The gain block 19 setting, in turn, is used to define the fixed balancing number 21 that is added to the first summing block 12 during setup. No other ionizer system employs a fixed balancing number 21, summing blocks 12, 13, an accumulator 18, and gain block 19 technology in an equivalent way to perform an equivalent matching procedure.

A second unique feature of the graphic interface 1 in FIG. 1 is the set gain button 3. The set gain button 3 in FIG. 1 initiates the first step of a three-step calibration procedure, and reflects the capability of locating the ionizers and remote sensors virtually anywhere in the work zone.

Again, the set gain button 3 of the graphical user interface 1 is novel because it initiates a novel calibration procedure. No prior art ionization system has an equivalent set gain button 3 that performs the same function in the same way.

After physically placing remote sensors and ionizers, the set gain button 3 initiates a gain level adjustment that (1) assures an adequate sensor signal-to-noise, and (2) assures a D/A converter operates in a well-resolved range. This is particularly important because the remote sensor is typically small, and it may be placed in a region where few air ions are present.

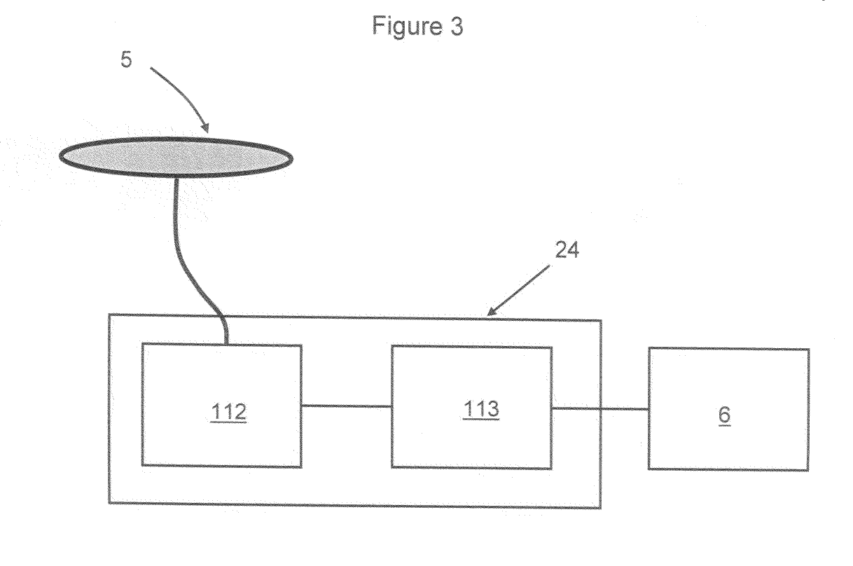

The set gain button 3 in FIG. 1 controls hardware and software described in FIG. 3. FIG. 3 shows ionizing system components that are affected by the set gain button 3 in FIG. 1.

In FIG. 3, a remote sensor plate 5 is connected to gain block 24, feeding D/A converter 6. The gain block 24 consists of a digitally-controlled analog amplifier 112, followed by a programmable-gain amplifier 113. The two amplifiers 112 and 113 are controlled and adjusted by the set gain button 3 of the graphical interface 1 in FIG. 1.

In a series of iterations, peak values of the signal waveform are quantified. If either peak value is near the limit or if the difference of the peak values is very high, amplifier 112, 113 gains are scaled down to prevent overload. Conversely, if the difference of the peak values is very low, amplifier 112, 113 gains are scaled up, for maximum sensitivity and noise immunity.

FIG. 3 also shows an D/A converter. The second function of the set-gain button 3 is to set the D/A converter 6 to operate in a highly resolved (upper) range.

Returning to FIG. 1, the graphic interface 1 contains a third unique feature. It is the calibrate button 4. The calibrate button 4 is employed during part of a calibration procedure. No prior art ionization system has an equivalent calibrate button 4 that performs the same calibration in the same way.

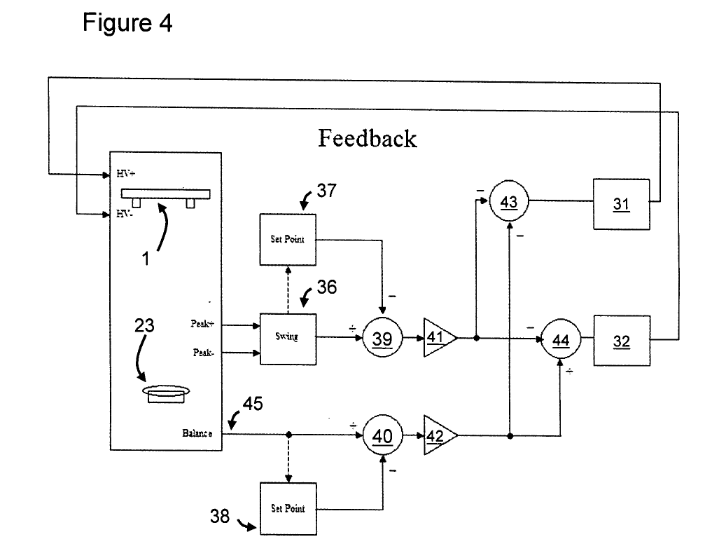

The calibrate field 4 in FIG. 1 is used to establish values for components shown in FIG. 4.

Refer to FIG. 4. The calibration feature tells a sensor 23 to zero itself by off-setting a balance signal 45 to match a zeroed CPM. This is accomplished by storing an offset value in a balance set point register 38.

At the same time, swing signal 36 and balance signals 45 from remote sensors 23 are converted into volts. The logical sequence for performing this is fully described in U.S. patent application Ser. No. 11/651,120, which has been incorporated by reference. Numerical references 31, 32, 37, 39, 40, 41, 42, 43, and 44 maintain the same descriptions found in U.S. patent application Ser. No. 11/651,120.

In functional terms, the offsetting of balance plus the matching of swing allow a remote sensor to mimic a charged plate monitor stationed at the target. This is true even when the target zone is distant from the remote sensor.

We claim:

1. A graphical user interface that allows an operator to monitor and control a system of multiple ionizers, multiple remote sensors, and an intermediate module comprising:
a feedback averages field for positive or negative feedback averages wherein,
said feedback averages indicate the percentage of an accumulator's output fed back to the input of said accumulator, and
said feedback averages determine the response time to correct an imbalance event; and
a set gain field which,
allows said ionizers and said remote sensors to be placed at a variety of locations within said system, and
determines the signal-to-noise or the resolution of a transmitted signal from said remote sensor; and
a calibrate field which,
matches the swing of said remote sensor to a known swing at a different position from said remote sensor, and
matches the balance of said remote sensor to a known swing at a different position from said remote sensor.

2. claim 1 where said accumulator is a component of said intermediate module.

3. claim 2 where said intermediate module is electrically connected between said remote sensors and said ionizers.

4. claim 1 where said feedback averages field is positioned within a table on at least one screen of said graphical user interface.

5. claim 4 where said table also includes a column heading containing any one category selected from a group consisting of (1) ionizer name, (2) sensor name, (3) mode, (4) positive output for ionizer, (5) negative output for ionizer, (6) positive on-time for ionizer, (7) negative on-time for ionizer, (8) positive off-time for ionizer, (9) negative off-time for ionizer, (10) positive feedback alarm, (11) negative feedback alarm, and (12) connected/disconnected.

6. claim 1 where said set gain field comprises a set gain button on at least one screen of said graphical user interface.

7. claim 6 where said set-gain button automatically sets said signal-to-noise or said resolution of said transmitted signal.

8. claim 6 where said set gain button causes a digital-to-analog converter to operate in a high resolution portion of its operating range.

9. claim 1 where said transmitted signal is received by a microprocessor that is contained within said intermediate module.

10. claim 9 where said microprocessor amplifies the balance portion of said transmitted signal from said remote sensor without modifying the swing portion of said transmitted signal.

11. claim 9 where said microprocessor sets said balance portion to zero when the balance at a target location is substantially zero.

12. claim 1 where said calibrate field comprises a calibrate button on at least one screen of said graphical user interface.

13. claim 12 where said calibrate button automatically performs remote sensor matching to a charge plate monitor.

14. claim 1 where said calibrate field is used to establish a scale factor in the graphical user interface software.

15. claim 1 where a fraction of said remote sensors are linked to a fraction of said ionizers via said intermediate module to provide feedback to said fraction of said ionizers.

16. claim 15 where feedback from said fraction of said remote sensors is used to change operating parameters of said fraction of said ionizers when linkage is established.

17. A static charge neutralizing system comprising:
one or more ionizers;
one or more remote sensors;
an intermediate module that
connects to both said ionizers and said remote sensors, and
controls bidirectional communication to said remote sensors and said ionizers; and
a microprocessor and an accumulator that are components of said intermediate module
wherein said microprocessor and said accumulator
amplify a balance portion of a transmitted signal from said remote sensor without affecting a swing portion of said transmitted signal,
set the balance of said remote sensor to zero when the balance of a charge plate monitor in a target location is substantially zero, and
match the swing of said remote sensor to a known swing in said target location; and
a graphic user interface that monitors or controls the functions of said static charge neutralization system.

18. claim 17 where said graphic user interface displays positive and negative feedback averages.

19. claim 18 where said positive and negative feedback averages indicate the level of feedback from the output of said accumulator to the input of said accumulator.

20. claim 18 where said positive and negative feedback averages monitor or adjust or determine the gain produced by said accumulator.

21. claim 17 where said accumulator determines the response time of said remote sensors.

22. claim 17 where said graphic user interface contains a gain field which adjusts the amplitude of remote sensor signals.

23. claim 22 where activating said gain field selects the signal-to-noise for said transmitted signal.

24. claim 22 where activating said gain field selects the resolution of a digital-to-analog converter.

25. claim 17 where said graphic user interface contains a calibrate field which allows ionizers and remote sensors to be placed at different locations within an ionized zone.

26. claim 25 where said calibrate field is utilized to offset the balance reading of said remote sensor to zero when the known balance at the target zone is substantially zero.

27. claim 25 where said calibrate field is used to match the swing of said remote sensor to a known swing at a target location.
